(19) United States
(12) Patent Application Publication
(10) Pub. No.: US 2023/0090321 A1
(43) Pub. Date: Mar. 23, 2023

(54) DRIVERS TO POWER LED ZONES

(71) Applicant: HEWLETT-PACKARD DEVELOPMENT COMPANY, L.P., Spring, TX (US)

(72) Inventors: Hsing-Hung Hsieh, Taipei City (TW); Kai-Chun Tai, Taipei City (TW); Yuan Hsi Chung, Taipei City (TW); Feng Cheng Lin, Taipei City (TW)

(73) Assignee: HEWLETT-PACKARD DEVELOPMENT COMPANY, L.P., Spring, TX (US)

(21) Appl. No.: 17/800,558

(22) PCT Filed: Feb. 28, 2020
(86) PCT No.: PCT/US2020/020361

§ 371 Date: Aug. 18, 2022

(51) Int. Cl. G09G 3/34; G09G 3/36

(52) U.S. Cl. CPC G09G 3/342; G09G 3/36; G09G 2330/021; G09G 2320/0686

(57) ABSTRACT

In some examples, an electronic device, comprises: a plurality of light emitting diodes (LEDs) arranged into first and second zones; and a driver coupled to the LEDs in the first and second zones, the driver to, in an image scan direction, provide a level of power to the LEDs in the first zone and to the LEDs in the second zone.

### BACKGROUND

Electronic devices such as televisions, notebooks, laptops, desktops, tablets, smartphones, and mobile devices are equipped with electronic displays. The electronic displays display images, such as documents, pictures, and videos, for viewing. Because of the variety of images that may be displayed, an electronic display should have a high rendering quality.

### BRIEF DESCRIPTION OF THE DRAWINGS

Various examples will be described below referring to the following figures:

FIG. 1 is a schematic diagram of an electronic device for driving, in an alternating fashion, light-emitting diodes (LEDs) arranged into zones, in accordance with various examples;

FIG. 2 is a timing diagram of a system for driving, in an alternating fashion, LEDs arranged into zones, in accordance with various examples;

FIG. 3 is a timing diagram of a system for driving, in an alternating fashion, LEDs arranged into zones, in accordance with various examples;

FIG. 4 is a schematic diagram of an electronic device for driving, in an alternating fashion, LEDs arranged into zones, in accordance with various examples;

FIG. 5 is a schematic diagram of an electronic device for driving, in an alternating fashion, LEDs arranged into zones, in accordance with various examples;

FIGS. 6a, 6b, and 6c are timing diagrams of a system for driving, in an alternating fashion, LEDs arranged into zones, in accordance with various examples; and

FIG. 7 is a flow diagram of a method for driving, in an alternating fashion, LEDs arranged into zones, in accordance with various examples.

### DETAILED DESCRIPTION

A method of achieving high performance utilizes local dimming of a liquid crystal display (LCD) having a light emitting diode (LED) backlight. Local dimming allows areas of LEDs of the LCD to be dimmed while keeping other areas of LEDs bright. The contrast between the dim and light areas of LEDs results in a higher quality image. To achieve higher levels of performance, the LEDs may be arranged into zones with each zone having a separate driver. However, when each zone has a separate driver, an amount of circuitry within the electronic device increases. The increase in the amount of circuitry results in a larger amount of space to accommodate the circuitry within the electronic device. The larger amount of space within the electronic device may result in a larger electronic device. In some instances, the thickness of the electronic display may increase. In other instances, a length, a width, or a combination of both may increase, though a viewing area of the electronic display may remain the same. The larger electronic device may not appeal to a consumer base. Additionally, the increase in circuitry and space increases the cost of the electronic device.

This disclosure describes various examples of an electronic device having a driver to provide, in an alternating fashion, a level of power to LEDs arranged into zones. Having a driver to provide the level of power to multiple zones reduces the number of drivers, saving circuitry and space within the electronic device while maintaining a high level of performance. The level of power causes the LEDs to emit light. In some examples, the level of power may be referred to in terms of a voltage. In other examples, the level of power may be referred to in terms of a current. The driver is an electronic circuit or component that provides the level of power in an alternating fashion by switching the level of power between the zones in a sequential manner. For example, the driver may provide the level of power to a first zone and then switch zones to provide the level of power to a second zone. In another example, the driver may provide the level of power simultaneously to a first zone and a second zone and then switch zones to provide the level of power simultaneously to a third zone and a fourth zone. In yet another example, the driver may provide the level of power simultaneously to a first zone and a third zone and then switch zones to provide the level of power to a second zone and a fourth zone.

The driving of the zones alternates in an image scan direction. The image scan direction may be vertical, flowing from a top of the display to a bottom of the display or from the bottom of the display to the top of the display, or it may be horizontal, flowing from a left of the display to a right of the display or from the right of the display to the left of the display. For example, if the image scan direction is vertical, flowing from a top of the display to a bottom of the display, and a first zone is closest to the top of the display, a third zone is closest to the bottom of the display, and a second zone is located between the first and third zones, then the driver provides the level of power to the first zone, then provides the level of power to the second zone, and then provides the level of power to the third zone. The driver provides the level of power to each zone for a time period of a time frame, where a duration of the time frame equals the inverse of an image refresh rate. The image refresh rate is the number of times an image refreshes, or is redrawn, per second. The image refresh rate may be a setting of the electronic device determined by a user or set during manufacture, for example. A duration of the time period is based on a multiplier that is equivalent to the number of zones.

The driver provides the level of power to each zone to produce an enhanced brightness, where the enhanced brightness is an amplification of an original brightness. The amplification, or enhanced brightness, is based on the multiplier that is equivalent to the number of zones. The “original brightness” is a measured brightness when multiple drivers provide the level of power to all LEDs of the multiple zones simultaneously to display an image for the time frame. For example, if the LEDs are arranged in two zones, then each zone couples to a different driver and the original brightness of each zone is measured. A first zone may have a first original brightness and a second zone may have a second original brightness, in some examples. In other examples, the first and second zones may have a same original brightness. A measurement of the enhanced brightness of a zone of multiple zones of LEDs driven by a single driver providing the level of power in an alternating fashion to display the image should be an amplification of the measured original brightness of that zone. Continuing the previous example of LEDs arranged in two zones, if an original brightness of a first zone is 250 nits, then an enhanced brightness when a driver drives the first zone of the two zones may be 500 nits. If an original brightness of a second zone is 300 nits, then an enhance brightness when a driver drives the second zone of the two zones may be 600 nits, for example.

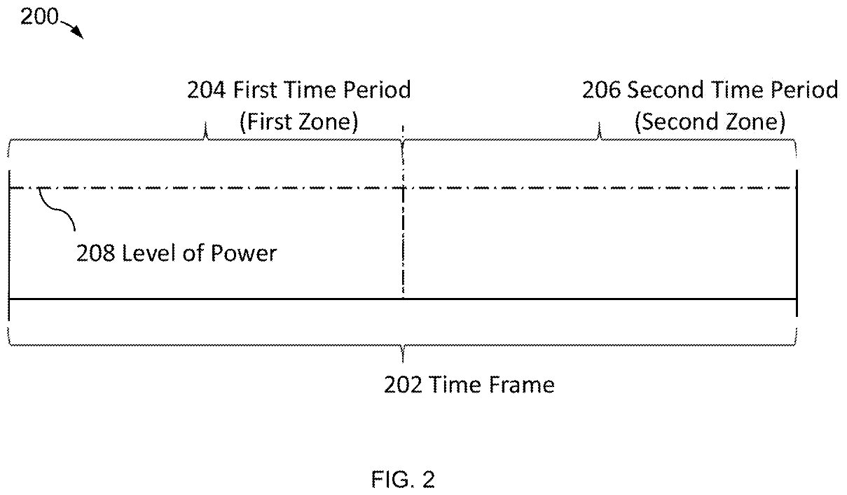

The driver provides the level of power to each zone, in an alternating fashion and in the image scan direction, to deliver the enhanced brightness for substantially equal time periods of the time frame. See discussion below with respect to FIG. 2 for an example. By utilizing the driver to provide the level of power to deliver an enhanced brightness in an alternating fashion to LEDs arranged into zones, the high performance of the electronic device is maintained while reducing the number of drivers coupled to the LEDs, thus reducing the cost of manufacture. Continuing the previous example of LEDs arranged in two zones, a number of drivers is reduced by half (i.e. from two to one), for example.

In one example in accordance with the present disclosure, an electronic device is provided. The electronic device comprises a plurality of LEDs arranged into first and second zones and a driver coupled to the LEDs in the first and second zones, the driver to alternatingly, in an image scan direction, provide a level of power to the LEDs in the first zone and to the LEDs in the second zone.

In another example in accordance with the present disclosure, a method is provided. The method comprises providing by a driver, during a first time period, a first level of power to LEDs in a first zone and a second level of power to LEDs in a second zone, the second level of power different than the first level of power; and providing by the driver, during a second time period, the second level of power to the LEDs in the first zone and the first level of power to the LEDs in the second zone.

In yet another example in accordance with the present disclosure, an electronic display is provided. The electronic display comprises a plurality of LEDs arranged in multiple zones; a switch coupled to the multiple zones; a driver coupled to the switch; a processor coupled to the driver; and a storage device coupled to the processor. The storage device comprises machine-readable instructions which, when executed, cause the processor to cause the driver to adjust the switch to access a first zone of the multiple zones; cause the driver to provide a level of power to the first zone during a first time period; cause the driver to adjust the switch to access a second zone of the multiple zones and to stop access to the first zone; and cause the driver to provide the level of power to the second zone during a second time period.

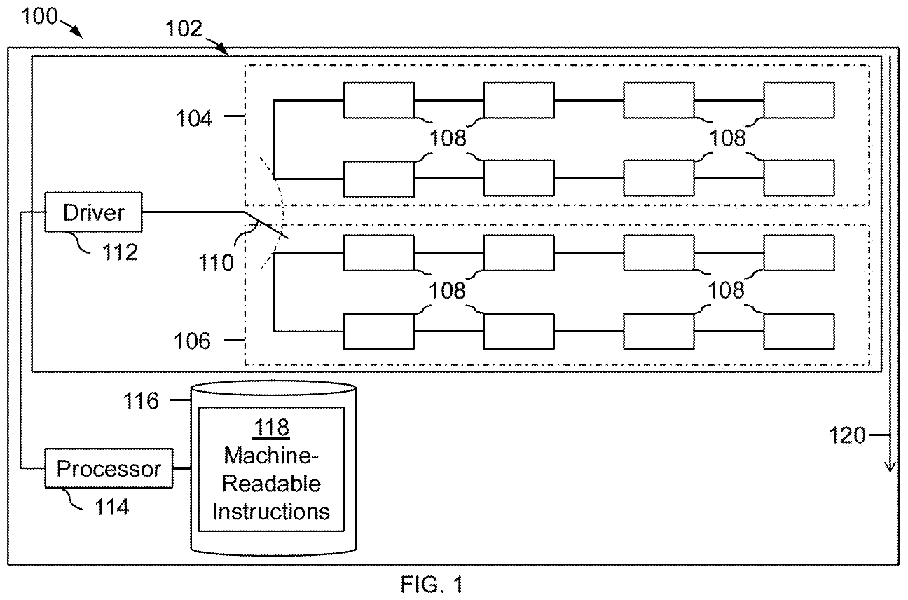

FIG. 1 is a schematic diagram of an electronic device 100 for driving, in an alternating fashion, light-emitting diodes (LEDs) arranged into zones 104, 106, in accordance with various examples. The electronic device 100 comprises an electronic display 102 coupled to a processor 114. The electronic device 100 may be an electronic device such as a desktop, a laptop, a notebook, a tablet, a smartphone, a mobile device, a television, or some other electronic device utilizing an electronic display, for example. The electronic display 102 comprises LEDs 108 arranged into zones 104, 106 and a driver 112 coupled to a switch 110. The electronic display 102 may be a liquid crystal display (LCD) with an LED backlight, for example. The driver 112 is an electronic circuit or component that provides the level of power in an alternating fashion by switching the level of power between the zones in a sequential manner. The driver 112 may be a transistor or an integrated circuit comprising multiple transistors, for example. The processor 114 is coupled to a storage device 116. The processor 114 may be a microprocessor, a microcontroller, a microcomputer, or other suitable controller, for example. The storage device 116 may be a hard drive, solid state drive (SSD), flash memory, random access memory (RAM), or other suitable memory, for example. In some examples, the storage device 116 may store machine-readable instructions 118, which, when executed, cause the processor 114 to perform some or all of the actions attributed herein to the processor 114.

In some examples, the electronic display 102 may be a flexible display. The term “flexible display” refers to an electronic display that may be deformed (e.g., rolled, folded, etc.) within a given parameter or specification (e.g., a minimum radius of curvature) without losing electrical function or connectivity. In various examples, the electronic display 102 may include a light guide plate. In other examples, the LCD may be an organic LCD (OLCD). In yet other examples, the LEDs may be mini LEDs. In various examples, the LEDs may be arranged into zones that are perpendicular to the image scan direction. During manufacture, the LEDs may be placed in rows and columns. A plurality of LEDs within a row, within a column, or some combination thereof, may be coupled to a driver. In In this manner, the LEDs are said to be “arranged” into zones. The image scan direction follows a gate line refresh sequence of the LCD. A gate line enables a line of pixels of the electronic display 102 to selectively turn on or off. When a gate line turns on, the image displayed by the pixels of the gate line may be refreshed. The gate line refresh sequence is the order in which liquid crystals of the LCD are driven. The gate line refresh sequence may be vertical, flowing from the top to the bottom or from the bottom to the top of the electronic display 102, or horizontal, flowing from the left to the right or from the right to the left of the electronic display 102. If the gate line refresh sequence is vertical, then the LEDs may be arranged into horizontal zones, for example. In another example, if the gate line refresh sequence is horizontal, then the LEDs may be arranged into vertical zones. In some examples, the gate line refresh sequence may first flow horizontally across multiple rows of liquid crystals of the LCD and then flow vertically to a next set of multiple rows of liquid crystals of the LCD.

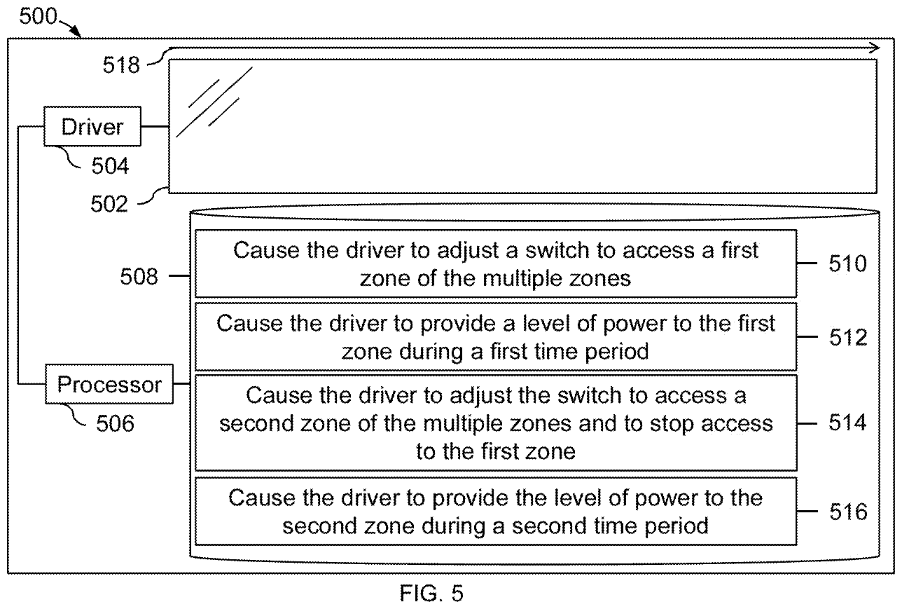

In various examples, the driver 112 may be located outside of the electronic display 102 but within the electronic device 100. In some examples, the electronic display 102 comprises the processor 114 and the storage device 116. Refer to the discussion below with respect to FIG. 5 for an example.

In some examples, execution of the machine-readable instructions 118 may cause the processor 114 to cause the driver 112 to provide, in an alternating fashion, a level of power to zones 104, 106. The zones 104, 106 may be alternately driven in an image scan direction 120. As discussed above, the image scan direction may be vertical, flowing from the top to the bottom or from the bottom to the top of the electronic display 102 or may be horizontal, flowing from the left to the right or from the right to the left of the electronic display 102. For example, the image scan direction 120 is vertical relative to the orientation of the electronic display 102 (e.g., base of electronic display 102 is parallel to bottom edge of FIG. 1).

In various examples, the processor 114 may directly couple to the switch 110. For example, execution of the machine-readable instructions 118 may cause the processor 114 to cause the switch 110 to enable access to the LEDs of zone 104. Execution of the machine-readable instructions 118 may cause the processor 114 to cause the driver 112 to provide the level of power to the LEDs of zone 104 for a first time period. Execution of the machine-readable instructions 118 may cause the processor 114 to cause the switch 110 to enable access to the LEDs of zone 106. Execution of the machine-readable instructions 118 may cause the processor 114 to cause the driver 112 to provide the level of power to the LEDs of zone 106 for a second time period. In other examples, the processor 114 may cause the driver 112 to control the switch 110. Refer to discussion with respect to FIG. 5, for example.

Referring now to FIG. 2, a timing diagram 200 of a system for driving, in an alternating fashion, light-emitting diodes (LEDs) arranged into zones is presented, in accordance with various examples. The system may be the electronic device 100, for example. The timing diagram 200 illustrates a time frame 202 during which a driver provides, in an alternating fashion, a level of power 208 to LEDs arranged into first and second zones. The driver may be the driver 112, for example. The first zone may be the zone 104, and the second zone may be the zone 106, for example. The time frame 202 comprises first and second time periods 204, 206, respectively. The first time period 204 represents a time period during which the driver provides the level of power 208 to the first zone. The second time period 206 represents a time period during which the driver provides the same level of power 208 to the second zone. A sum of a duration of the first time period 204 and a duration of the second time period 206 equals a duration of the time frame 202.

As discussed above, the duration of the time frame 202 equals the inverse of an image refresh rate. For example, if the image refresh rate is 60 hertz (Hz), then a duration of the time frame 202 equals 1/60 seconds, or 0.016 seconds. As discussed above, the duration of the time period is based on a multiplier that is equivalent to the number of zones. The LEDs in a zone are driven for a time period equal to a fraction of the time frame, the fraction equal to an inverse of the multiplier. For example, the driver of the system on which the timing diagram 200 is based is providing the level of power 208 to two zones, so the multiplier is 2 and each time period is driven for ½ of the time frame 202. Assuming the image refresh rate is 60 Hz, the driver for the system of the timing diagram 200 provides the level of power 208 to each zone for a duration equal to ½ of 0.016 seconds, or 0.008 seconds. As discussed above, if the duration for each time period is summed, then the sum equals the time frame. For example, 0.008 secs (e.g., first time period 204) added to 0.008 secs (e.g., second time period 206) equals 0.016 seconds (e.g., time frame 202).

As discussed above, to enhance performance, the driver provides a level of power to each zone to provide an enhanced brightness, where the enhanced brightness is based on the multiplier that is equivalent to the number of zones. For example, the driver of the system on which the timing diagram 200 is based provides the level of power 208 to each zone so that the brightness of the zone is two times an original brightness. The driver provides the level of power 208 to each zone, in an alternating fashion, to deliver the enhanced brightness for equal durations of the time frame. For example, the driver of the system on which the timing diagram 200 is based provides the level of power 208 to the first zone to deliver twice the original brightness during the first half of the time frame 202 and then to the second zone to deliver twice the original brightness during the second half of the time frame 202. By utilizing the driver to provide the level of power to deliver an enhanced brightness in an alternating fashion to LEDs arranged into zones, the performance of the electronic device is maintained while reducing a number of drivers needed to provide power, thus reducing a size and cost of manufacture of the electronic device.

Returning to FIG. 1, in various examples, the driver 112 may drive multiple zones. For example, if each row of LEDs 108 in zones 104, 106 were a zone (e.g., first row of zone 104 is a zone 104a, second row of zone 104 is a zone 104b, first row of zone 106 is a zone 106a, second row of zone 106 is a zone 106b), then the driver 112 may drive the LEDs of zones 104a, 104b in an alternating fashion with the LEDs of zones 106a, 106b. In some examples, the driver 112 may couple to multiple switches. For example, if zones 104, 106 are subdivided into zones 104a, 104b, 106a, 106b, then a first switch may enable the driver 112 to provide a level of power to the LEDs of zones 104a, 104b and a second switch may enable the driver 112 to provide the level of power to the LEDs of zones 106a, 106b. The driver 112 may control the first and second switches to enable providing the level of power to the LEDs of zones 104a, 104b, 106a, 106b in an alternating fashion in the image scan direction 120. For example, the driver 112 may cause the first switch to access the LEDs of zone 104a. The driver 112 may provide the level of power to the LEDs of zone 104a for a first time period. The driver 112 may cause the first switch to access the LEDs of zone 104b. The driver 112 may provide the level of power to the LEDs of zone 104b for a second time period. The driver 112 may cause the first switch to disable access to the LEDs of zones 104a, 104b. The driver 112 may cause the second switch to access the LEDs of zone 106a. The driver 112 may provide the level of power to the LEDs of zone 106a for a third time period. The driver 112 may cause the second switch to access the LEDs of zone 106b. The driver 112 may provide the level of power to the LEDs of zone 106b for a fourth time period.

In various examples, the LEDs of a zone may be subdivided into groups. The groups may be controlled by a switch or by multiple switches. For example, each column of zone 104 (e.g., LEDs aligned vertically) may be arranged together. The first column of LEDs 108 of zone 104 may be a first group, the second column of LEDs 108 of zone 104 may be a second group, the third column of LEDs 108 of zone 104 may be a third group, and the fourth column of LEDs 108 of zone 104 may be a fourth group. In some examples, a switch may enable access to the LEDs of the first, second, third, and fourth groups. In other examples, a first switch may enable access to the LEDs of the first and second groups, and a second switch may enable access to the LEDs of the third and fourth groups.

In some examples, the driver 112 may provide, in an alternating fashion in a horizontal image scan direction, a level of power to groups of LEDs in a first zone before providing, in an alternating fashion in the horizontal image scan direction, the level of power to groups of LEDs in a second zone in a horizontal image scan direction. For example, utilizing the previous example in which zones 104, 106 were each subdivided into first and second groups controlled by a first switch and third and fourth groups controlled by a second switch, execution of the machine-readable instructions 118 may cause the processor to cause the driver 112 to cause the switch 110 to enable access to the LEDs of zone 104. Execution of the machine-readable instructions 118 may cause the processor 114 to cause the driver 112 to cause the first switch to enable access to the first group of LEDs of zone 104. Execution of the machine-readable instructions 118 may cause the processor 114 to cause the driver 112 to provide a level of power to the first group of LEDs of zone 104. Execution of the machine-readable instructions 118 may cause the processor 114 to cause the driver 112 to cause the first switch to enable access to the second group of LEDs of zone 104. Execution of the machine-readable instructions 118 may cause the processor 114 to cause the driver 112 to provide the level of power to the second group of LEDs of zone 104.

Execution of the machine-readable instructions 118 may cause the processor 114 to cause the driver 112 to cause the first switch to disable access to the first and second groups of LEDs of zone 104. Execution of the machine-readable instructions 118 may cause the processor 114 to cause the driver 112 to cause a second switch to enable access to the third group of LEDs of zone 104. Execution of the machine-readable instructions 118 may cause the processor 114 to cause the driver 112 to provide the level of power to the third group of LEDs of zone 104. Execution of the machine-readable instructions 118 may cause the processor 114 to cause the driver 112 to cause the second switch to enable access to the fourth group of LEDs of zone 104. Execution of the machine-readable instructions 118 may cause the processor 114 to cause the driver 112 to provide the level of power to the fourth group of LEDs of zone 104. Execution of the machine-readable instructions 118 may cause the processor 114 to cause the driver 112 to cause the switch 110 to enable access to the LEDs of zone 106. Execution of the machine-readable instructions 118 may cause the processor 114 to cause the driver 112 to drive groups of LEDs of zone 106.

In various examples, the driver 112 may provide, in an alternating fashion in a horizontal image scan direction, a level of power to multiple groups of LEDs in a first zone before providing, in an alternating fashion in the horizontal image scan direction, the level of power to multiple groups of LEDs in a second zone in a horizontal image scan direction. For example, utilizing the previous example in which zones 104, 106 were each subdivided into first and second groups controlled by a first switch and third and fourth groups controlled by a second switch, execution of the machine-readable instructions 118 may cause the processor to cause the driver 112 to cause the switch 110 to enable access to the LEDs of zone 104. Execution of the machine-readable instructions 118 may cause the processor 114 to cause the driver 112 to cause the first switch to enable access to the first group of LEDs of zone 104. Execution of the machine-readable instructions 118 may cause the processor 114 to cause the driver 112 to cause the second switch to enable access to the third group of LEDs of zone 104. Execution of the machine-readable instructions 118 may cause the processor 114 to cause the driver 112 to provide a level of power to the first and third groups of LEDs of zone 104. Execution of the machine-readable instructions 118 may cause the processor 114 to cause the driver 112 to cause the first switch to enable access to the second group of LEDs of zone 104. Execution of the machine-readable instructions 118 may cause the processor 114 to cause the driver 112 to cause the second switch to enable access to the fourth group of LEDs of zone 104. Execution of the machine-readable instructions 118 may cause the processor 114 to cause the driver 112 to provide the level of power to the second and fourth groups of LEDs of zone 104. Execution of the machine-readable instructions 118 may cause the processor 114 to cause the driver 112 to cause the switch 110 to enable access to the LEDs of zone 106. Execution of the machine-readable instructions 118 may cause the processor 114 to cause the driver 112 to drive groups of LEDs of zone 106 in a similar fashion to the driving of the groups of LEDs of zone 104.

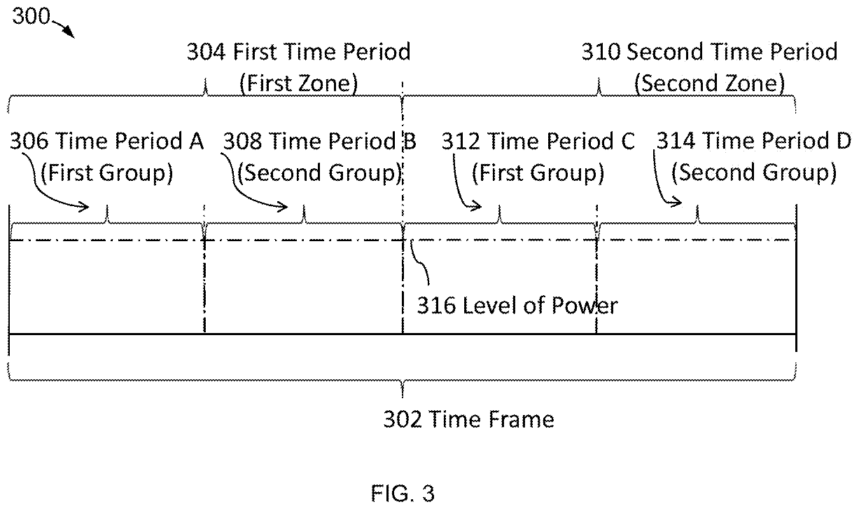

Referring now to FIG. 3, a timing diagram 300 of a system for driving, in an alternating fashion, LEDs arranged into zones is presented, in accordance with various examples. The system may be the electronic device 100, for example. The driver may be the driver 112, for example. The first and second zones may be the zones 104, 106, for example. The time frame 302 comprises first and second time periods 304, 310, respectively. The first time period 304 represents a time period during which the driver provides a level of power 316 to the first zone. The second time period 310 represents a time period during which the driver provides the level of power 316 to the second zone. The first time period 304 is subdivided into a time period 306 (e.g., Time Period A) and a time period 308 (e.g., Time Period B). The time periods 306, 308 are time periods during which the driver provides the level of power 316 to a first group and a second group of the first zone. A duration of each time period 306, 308 is also referred to herein as a portion, or fraction, of a duration of the first time period 304. A sum of the duration of the time period 306 and the duration of the time period 308 equals the duration of the first time period 304. The second time period 310 is subdivided into a time period 312 (e.g., Time Period C) and a time period 314 (e.g., Time Period D). The time periods 312, 314 are time periods during which the driver provides the level of power 316 to a first group and a second group of the second zone. A duration of each time period 312, 314 is also referred to herein as a portion, or fraction, of a duration of the second time period 310. A sum of a duration of the time period 312 and a duration of the time period 314 equals a duration of the second time period 310. A sum of the durations of the time periods 306, 308, 312, 314 equals the duration of the time frame 302.

When a zone is subdivided into groups, a duration of a time period for a group of a zone is based on a second multiplier that is equivalent to the number of zones multiplied by the number of groups within a zone. The driver of the system on which the timing diagram 300 is based is providing the level of power 316 to two zones having two groups, so the second multiplier equals four (e.g., 2 multiplied by 2). The LEDs in a group of a zone are driven for a time period equal to a fraction of the time frame, the fraction equal to an inverse of the second multiplier. A duration of each time period 306, 308, 312, 314 equals ¼ of the time frame 302. For example, assuming the image refresh rate is 60 Hz, then a duration of the time frame 302 equals 0.016 seconds, as discussed above with respect to FIG. 2, and the driver for the system of the timing diagram 300 provides the level of power 316 to each group for a duration equal to ¼ of 0.016 seconds, or 0.004 seconds.

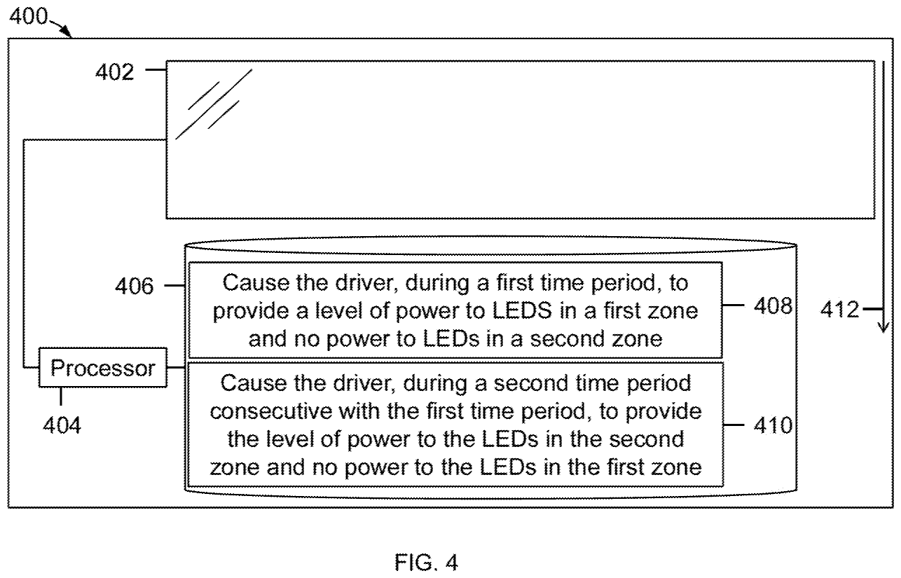

Referring now to FIG. 4, a schematic diagram of an electronic device 400 is shown for driving, in an alternating fashion, LEDs arranged into zones, in accordance with various examples. The electronic device 400 comprises an electronic display 402 coupled to a processor 404. The electronic device 400 may be the electronic device 100, for example. The electronic display 402 may be the electronic display 102, for example. The processor 404 is coupled to a storage device 406. The processor 404 may be the processor 114, for example. The storage device 406 may be the storage device 116, for example. The storage device 406 may store machine-readable instructions 408 and 410. Execution of the machine-readable instructions 408, 410 may cause the processor 404 to perform some or all of the actions attributed herein to the processor 404.

In some examples, the machine-readable instructions 408, 410 may be machine-readable instructions 118, for example. The machine-readable instructions 408, 410 may be for execution by the processor 404. The machine-readable instructions 408, 410 may cause the processor 404 to drive, in an alternating fashion, LEDs arranged into zones. Execution of instruction 408 may cause the processor 404 to cause a driver (e.g., driver 112), during a first time period, to provide a level of power to LEDs in a first zone (e.g., zone 104) and no power to LEDs in a second zone (e.g., zone 106). Execution of instruction 410 may cause the processor 404 to cause the driver, during a second time period consecutive with the first time period, to provide the level of power to the LEDs in the second zone and no power to the LEDs in the first zone.

In various examples, the processor 404 determines the level of power based on a multiplier. As discussed above with respect to FIG. 2, the multiplier equals the number of zones to which the driver provides the level of power. For example, if the driver provides power to four zones, then the processor 404 determines the multiplier equals four. The processor 404 may cause the driver to provide a level of power sufficient to enhance a brightness of the LEDs in a zone by four times. By utilizing the driver to provide the level of power to deliver an enhanced brightness in an alternating fashion to LEDs arranged into four zones, the performance of the electronic device as if each of the four zones is driven by a separate driver is maintained while reducing a number of drivers needed to provide power by four, thus reducing a size and cost of manufacture of the electronic device.

In other examples, driving the first zone followed by the second zone should match an image scan direction 412. For example, if the image scan direction is vertical from top to bottom, then the zones should be driven vertically from top to bottom as well. The driving occurs in an alternating fashion. For example, if the first zone is located closer to the top of the display than the second zone, then the processor 404 may drive the first zone during the first time period of the time frame and the second zone during the second time period of the time frame and then repeat the order for subsequent time frames.

In various examples, driving multiple zones should match the image scan direction 412. For example, if the image scan direction 412 is vertical from top to bottom, then the zones should be driven vertically from top to bottom as well. The driving occurs in an alternating fashion. For example, the driver provides the level of power to a first zone and then switches to provide the level of power to a second zone. In some examples, the driver may provide the level of power to multiple non-sequential zones for a first time period and then to other multiple non-sequential zones for a second time period. For example, if the driver provides the level of power to four zones and the first zone is located closer to the top of the display, the fourth zone is located closer to the bottom of the display, and the second zone and the third zone are located sequentially in between, then the processor 404 may drive the zones in a non-sequential manner that flows vertically from top to bottom. The processor 404 may provide the level of power simultaneously to the first and third zones for the first time period and then switch to provide the level of power simultaneously to the second and fourth time zones during a second time period.

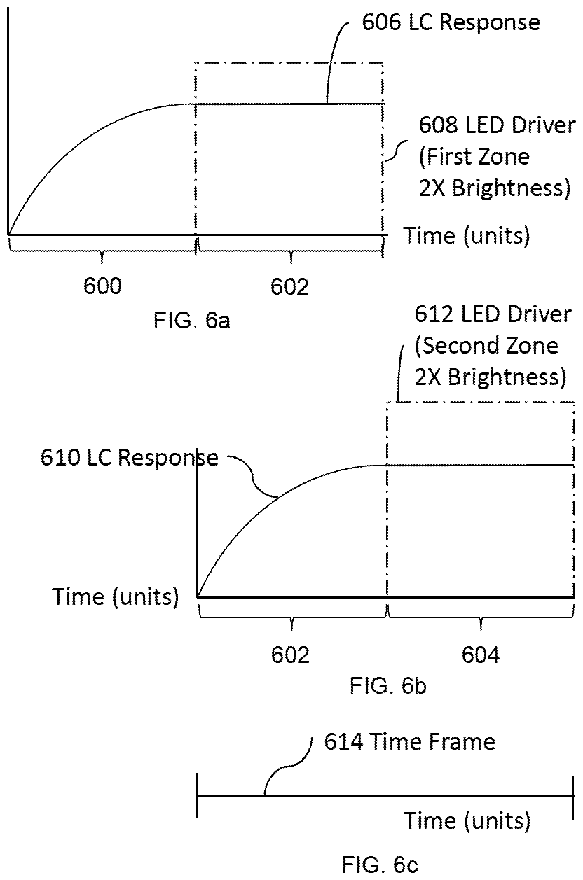

Reference is now briefly made to FIGS. 6a, 6b, and 6c prior to turning to FIG. 5. Referring now to FIGS. 6a, 6b, and 6c, timing diagrams of a system for driving, in an alternating fashion, LEDs arranged into zones are presented, in accordance with various examples. The system may be the electronic device 100, for example. The zones may be the zones 104, 106 for example. The timing diagrams 608, 612 illustrate an LED driver of the system driving a first zone (see FIG. 6a) and then a second zone (see FIG. 6b). The LED driver may be the driver 112, for example. The timing diagram of FIG. 6c illustrates a time frame 614 during which the LED driver provides, in an alternating fashion, a level of power to the first and second zones.

FIG. 6a illustrates a timing diagram 606 for a liquid crystal of the LCD. The timing diagram 606 illustrates a response of the liquid crystal after a voltage is applied to reposition the liquid crystal. The timing diagram 608 illustrates when the LED driver provides a level of power to an LED associated with the liquid crystal. The LED associated with the liquid crystal may be an LED of zone 104, for example. During a first time period 600, the timing diagram 606 illustrates the liquid crystal repositioning in response to the application of the voltage. During a second time period 602, the timing diagram 606 illustrates the liquid crystal is repositioned. During the second time period 602, the LED driver is providing the level of power to the first zone to deliver an enhanced brightness.

FIG. 6b illustrates a timing diagram 610 for another liquid crystal of the LCD. The timing diagram 610 illustrates a response of the another liquid crystal after a voltage is applied to reposition the another liquid crystal. The timing diagram 612 illustrates when the LED driver provides the level of power to an LED associated with the another liquid crystal. The LED associated with the another liquid crystal may be an LED of zone 106, for example. During the first time period 602, the timing diagram 610 illustrates the another liquid crystal repositioning in response to the application of the voltage. During a third time period 604, the timing diagram 610 illustrates the liquid crystal is repositioned. During the third time period 604, the LED driver is providing the level of power to the second zone to deliver an enhanced brightness.

During the first time period 600, the LED driver provides no power to either the first zone or the second zone. During the second time period 602, the LED driver provides the level of power to the LED of the first zone, as illustrated by the timing diagram 608, and no power to the second zone, as illustrated by the timing diagram 612. During the third time period 604, the LED driver provides no power to the first zone and the level of power to the LED of the second zone. As discussed above with respect to FIG. 2, if a duration for each time period during which LEDs of zones are driven is summed, then the sum equals a duration of the time frame. As illustrated by FIGS. 6a, 6b, and 6c, a duration of the second time period 602 plus a duration of the third period 604 equals a duration of the time frame 614.

In some examples, a liquid crystal receives a voltage for a duration equal to a time frame. As discussed above, a duration of the time frame equals the inverse of an image refresh rate. For example, if the image refresh rate is 100 Hz, then the time frame equals 1/100 secs or 0.01 secs. To ensure the liquid crystal is repositioned, the LED driver may provide the level of power to the LED associated with the liquid crystal during a final portion of the time frame, where a duration of the final portion equals a fraction of the time frame. The fraction is based on the multiplier that is equal to the number of zones driven by the LED driver. For example, if the LED driver drives two zones, then the fraction equals ½. The LED driver may drive a first zone during the final 0.005 secs of the time frame during which the liquid crystal receives the voltage.

Referring now to FIG. 5, a schematic diagram of an electronic display 500 for alternately driving LEDs arranged into zones is presented, in accordance with various examples. The electronic display 500 may be the electronic display 102, for example. The electronic display 500 comprises a liquid crystal display (LCD) having an LED backlight 502 coupled to a processor 506. The LCD having an LED backlight 502 may comprise LEDs 108 arranged into zones 104, 106 and a driver 112 coupled to a switch 110, for example. The processor 506 is coupled to a storage device 508. The processor 506 may be a microprocessor, a microcontroller, a microcomputer, or other suitable controller, for example. The storage device 508 may be a hard drive, solid state drive (SSD), flash memory, random access memory (RAM), or other suitable memory, for example. The storage device 508 may store machine-readable instructions 510, 512, 514, and 516. Execution of the machine-readable instructions 510, 512, 514, 516 may cause the processor 506 to perform some or all of the actions attributed herein to the processor 506.

The machine-readable instructions 510, 512, 514, 516 may be the machine-readable instructions 118, for example. The machine-readable instructions 510, 512, 514, 516 may be for execution by the processor 506. The machine-readable instructions 510, 512, 514, 516 may cause the processor 506 to alternately drive LEDs arranged into zones. Execution of instruction 510 may cause the processor 506 to cause the driver 504 to adjust a switch to access a first zone of multiple zones. Execution of instruction 512 may cause the processor 506 to cause the driver 504 to provide a level of power to a first zone during a first time period. Execution of instruction 514 may cause the processor 506 to cause the driver 504 to adjust the switch to access a second zone of the multiple zones and to stop access to the first zone. Execution of instruction 516 may cause the processor 506 to cause the driver 504 to provide the level of power to the second zone during a second time period.

In various examples, the processor 506 causes the driver 504 to provide the level of power to the first and second zones in an image scan direction 518.

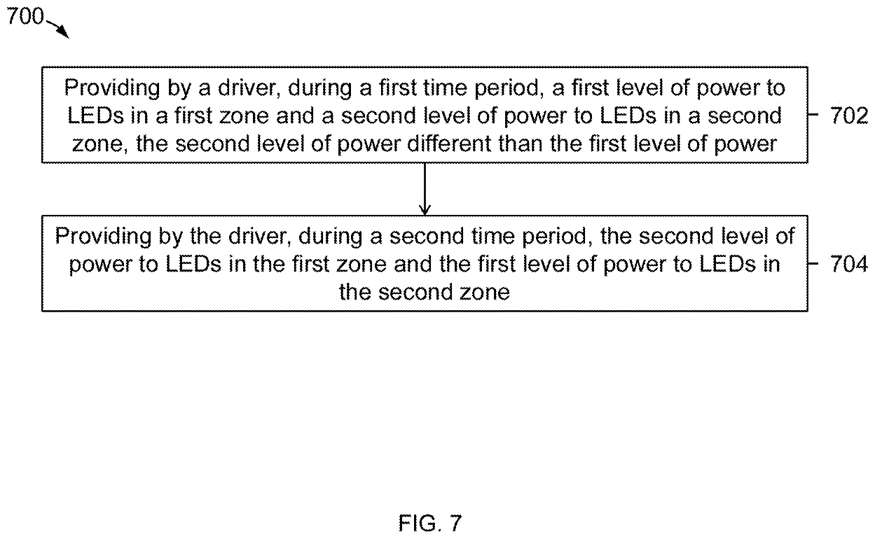

FIG. 7 is a flow diagram of a method 700 for alternately driving LEDs arranged into zones, in accordance with various examples. The method 700 may be performed, for example, by the processor 114, 404, 506. The LEDs may be LEDs of an electronic display 102, 402, 500, for example. The method 700 includes providing by a driver, during a first time period, a first level of power to LEDs in a first zone and a second level of power to LEDs in a second zone, the second level of power different than the first level of power (702). The driver may be the driver 112, 504, for example. The first zone may be the zone 104, for example. The second zone may be the zone 106, for example. The method 700 also includes providing by the driver, during a second time period, the second level of power to LEDs in the first zone and the first level of power to LEDs in the second zone (704).

In some examples, the method 700 includes driving, in an alternating fashion, the first and second zones in an image scan direction. The image scan direction may be the image scan direction 120, 412, 518, for example.

In various examples, the method 700 includes providing by a switch, during the first time period, access to LEDs in the first zone. The switch may be the switch 110, for example. The processor 114 may utilize the method 700 to cause the switch to enable access to LEDs in the first zone and disable access to LEDs in the second zone. In another example, the processor 114 may utilize the method 700 to cause the driver to cause the switch to enable access to LEDs in the first zone.

In other examples, the method 700 includes providing by the driver, during the first time period, the first level of power to LEDs of a first set of zones and the second level of power to LEDs of a second set of zones. The method 700 includes providing by the driver, during the second time period, the second level of power to LEDs in the first set of zones and the first level of power to LEDs of the second set of zones.

In some examples, the method 700 includes providing by the driver, during the first time period, the first level of power to subgroups of LEDs of the first zone in an alternating fashion. For example, if the first zone comprises two subgroups, then the method 700 includes providing by the driver, during a first half of the first time period, the first level of power to the first subgroup and the second level of power to the second subgroup of the first zone and providing by the driver, during a second half of the first time period, the second level of power to the first subgroup and the first level of power to the second subgroup of the first zone.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the terms “including” and “comprising” are used in an open-ended fashion, and thus should be interpreted to mean “including, but not limited to. . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.” In addition, when used herein, the word “generally” or “substantially” means within a range of plus or minus 10% of the stated value.

What is claimed is:

1. An electronic device, comprising:
a plurality of light emitting diodes (LEDs) arranged into first and second zones; and
a driver coupled to the LEDs in the first and second zones, the driver to alternatingly, in an image scan direction, provide a level of power to the LEDs in the first zone and to the LEDs in the second zone.

2. The electronic device of claim 1, comprising a processor that is to determine a multiplier, the multiplier based on a number of zones coupled to the driver.

3. The electronic device of claim 2, wherein the level of power is based on the multiplier.

4. The electronic device of claim 3, wherein, during a first time period, the driver is to provide the level of power to the LEDs in the first zone and no power to the LEDs in the second zone, and wherein, during a second time period consecutive with the first time period, the driver is to provide the level of power to the LEDs in the second zone and no power to the LEDs in the first zone.

5. The electronic device of claim 4, wherein a duration of the first time period is based on a number of zones having LEDs coupled to the driver.

6. A method, comprising:
providing by a driver, during a first time period, a first level of power to light emitting diodes (LEDs) in a first zone and a second level of power to LEDs in a second zone, the second level of power different than the first level of power; and
providing by the driver, during a second time period, the second level of power to the LEDs in the first zone and the first level of power to the LEDs in the second zone.

7. The method of claim 6, comprising driving, by the driver, the LEDs in the first and second zones in a direction that matches an image scan direction.

8. The method of claim 6, comprising determining the first level of power based on a number of LED zones to which the driver is to provide the first level of power.

9. The method of claim 6, wherein the first time period is equivalent to a duration of a time frame divided by a number of zones, the duration of the time frame based on an image refresh rate.

10. The method of claim 9, wherein a sum of the first time period and the second time period is equivalent to the time frame.

11. An electronic display, comprising:
a plurality of light emitting diodes (LEDs) arranged in multiple zones;
a switch coupled to the multiple zones;
a driver coupled to the switch;
a processor coupled to the driver; and
a storage device coupled to the processor, the storage device comprising machine-readable instructions which, when executed, cause the processor to:
cause the driver to adjust the switch to access a first zone of the multiple zones;
cause the driver to provide a level of power to the first zone during a first time period;
cause the driver to adjust the switch to access a second zone of the multiple zones and to stop access to the first zone; and
cause the driver to provide the level of power to the second zone during a second time period.

12. The electronic display of claim 11, comprising:
another switch coupled to two or more groups of the plurality of LEDs arranged in the first zone, the two or more groups comprising at least one LED per group; and
the driver coupled to the another switch.

13. The electronic display of claim 12, wherein execution of the machine-readable instructions causes the processor to:
cause the driver to adjust the another switch to access a first group of the two or more groups;
cause the driver to provide the level of power to the first group during a first portion of the first time period;
cause the driver to adjust the another switch to access a second group of the two or more groups; and
cause the driver to provide the level of power to the second group during a second portion of the first time period.

14. The electronic display of claim 13, wherein a duration of the first portion of the first time period is equivalent to a duration of a time frame divided by a number of zones divided by the number of groups in the first zone, the duration of the time frame based on an image refresh rate.

15. The electronic display of claim 11, comprising multiple liquid crystals corresponding to the LEDs in the first zone, wherein the driver is to provide the level of power to the first zone after a voltage is applied to the multiple liquid crystals to reposition the multiple liquid crystals.
